(19) United States
(12) Patent Application Publication
(10) Pub. No.: US 2007/0214716 A1
(43) Pub. Date: Sep. 20, 2007

(54) Domestic Seeding Device

(75) Inventor: Dario Bavicchi, Perugia (IT)

Correspondence Address: MAINE & ASMUS, 100 MAIN STREET, P O BOX 3445, NASHUA, NH, 03061-3445, US

(73) Assignee: BAVICCHI SPA, Ponte S. Giovanni (IT)

(21) Appl. No.: 10/598,137

(22) PCT Filed: Feb. 17, 2005
(86) PCT No.: PCT/IB05/00395

§ 371 Date: Aug. 18, 2006

(30) Foreign Application Priority Data
Feb. 19, 2004 (IT) UD2004A000028

(51) Int. Cl. A01G 31/06

(52) U.S. Cl. 47/59 R

(57) ABSTRACT

A domestic seeding device comprising at least two substantially flat containers able to stacked one on top of the other, each of which receives a layer of seeds for the domestic cultivation of relative hydroculture shoots. The device also comprises at least a supporting and distancing element arranged between every pair of adjacent containers, in order to define between the latter a gap for the passage of a flow of air in contact with the seeds/shoots arranged in every container.

### FIELD OF THE INVENTION

The present invention concerns a domestic seeding device comprising at least two substantially flat containers able to be stacked one on top of the other, each of which is suitable for the domestic cultivation of shoots in hydroculture.

### BACKGROUND OF THE INVENTION

It is known that in recent years there has been a growing need on the part of consumers to ensure that the vegetable produce they purchase has been grown naturally and has not been subjected to contaminating or polluting treatments of any kind.

In order to satisfy this need, seeding devices of a domestic type have been devised, normally consisting of a plurality of substantially flat containers, able to be stacked one on top of the other, and inside each of which a layer of seeds is deposited, which can advantageously be different from container to container, to allow the autonomous cultivation in hydroculture of various types of vegetable foodstuffs such as chick peas, mushrooms, beans, soya, rocket, lamb's lettuce or others.

These conventional domestic seeding devices need constant attention from the user, however, since the seeds in every container, from the one at the top of the pile to the one at the bottom, must be irrigated uniformly and with a sufficient quantity of water, and also kept in specific environmental conditions of temperature and humidity, to prevent the development of molds and the malformation of the shoots.

Among the domestic seeding device currently developed, those that can be associated with automatic irrigation systems are also known.

One purpose of the present invention is to achieve a domestic seeding device which is simple to use for the user and which limits as much as possible the development of molds on the shoots. Another purpose is to ensure that the irrigation of all the containers, whether this is achieved manually or automatically, is uniform and with a sufficient quantity of water for correct growth.

The present Applicant has devised, tested and embodied this invention to overcome the shortcomings of the state of the art and to obtain these and other purposes and advantages.

### SUMMARY OF THE INVENTION

The present invention is set forth and characterized in the main claim, while the dependent claims describe other characteristics of the invention or variants to the main inventive idea.

In accordance with said purposes, a domestic seeding device according to the present invention comprises at least two substantially flat containers, able to be stacked one on top of the other, each of which is able to receive a layer of seeds for the domestic cultivation of relative shoots in hydroculture, and at least a supporting and distancing element arranged between every pair of adjacent containers and able to define a gap which allows the passage of a flow of air in contact with the seeds/shoots arranged in every container.

In this way the containers are ventilated, thus preventing the formation of molds on the shoots which develop inside them.

According to a variant, the supporting and distancing element comprises an axial through conduit able to be arranged coaxially to a central through hole provided on the container, and as an extension of an analogous axial conduit present in the supporting and distancing element. In this way it is possible to create a substantially continuous channel which allows to feed water from below, for example by means of a pump associated with a feed source, and to make it emerge from the top of the pile, supplying the water for irrigation, as we shall see later, to all the containers.

To allow the passage of the water from the container above to the container below, every container comprises, on its bottom wall, a plurality of through apertures.

In a preferential embodiment, the through apertures have a cross section shaped substantially like an upside-down V, so as to promote the passage of the water from the top downwards, to prevent the formation of static drops and prevent the apertures from possibly being blocked by the roots emerging from the seeds.

In this way, by making the water pass from the bottom upwards through the axial conduits of the various supporting and distancing elements provided, the water emerges from the last of the elements and falls in sequence through the through apertures onto the containers below, thus irrigating like rain all the seeds/shoots arranged in the various containers.

In a preferential form of embodiment, the upper face of the bottom wall of each container has a plurality of ridges, knurls or similar, which increase the contact surface between the seeds/shoots and the bottom of the container, thus improving the conditions of water exchange.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a sectioned side view of a domestic seeding device according to the present invention;

FIG. 2 is a view from above of a container of the seeding device in FIG. 1;

FIG. 3 shows an enlargement of the detail III of the seeding device in FIG. 1.

### DETAILED DESCRIPTION OF A PREFERENTIAL FORM OF EMBODIMENT

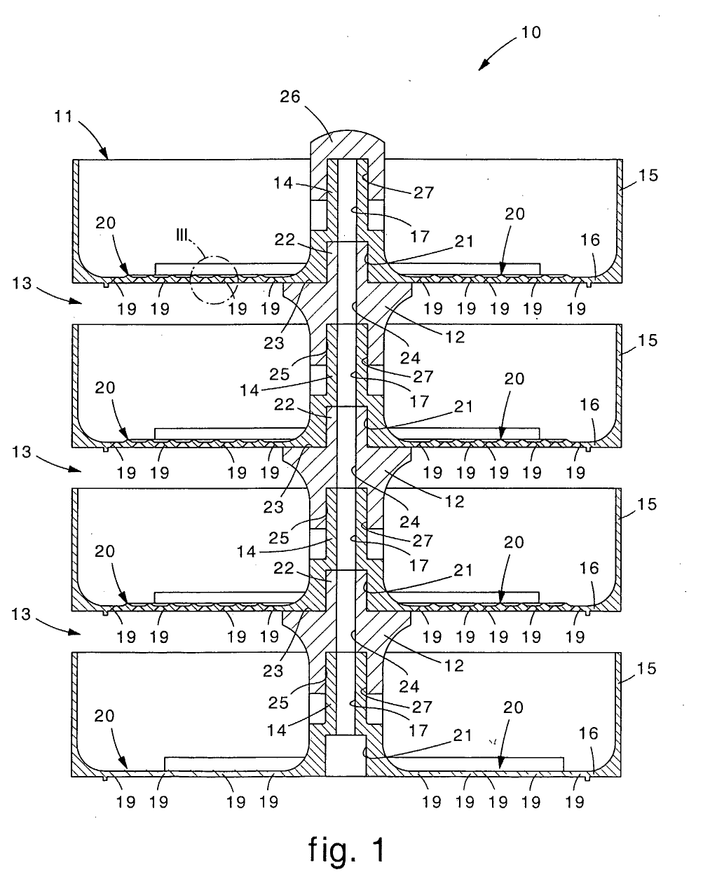

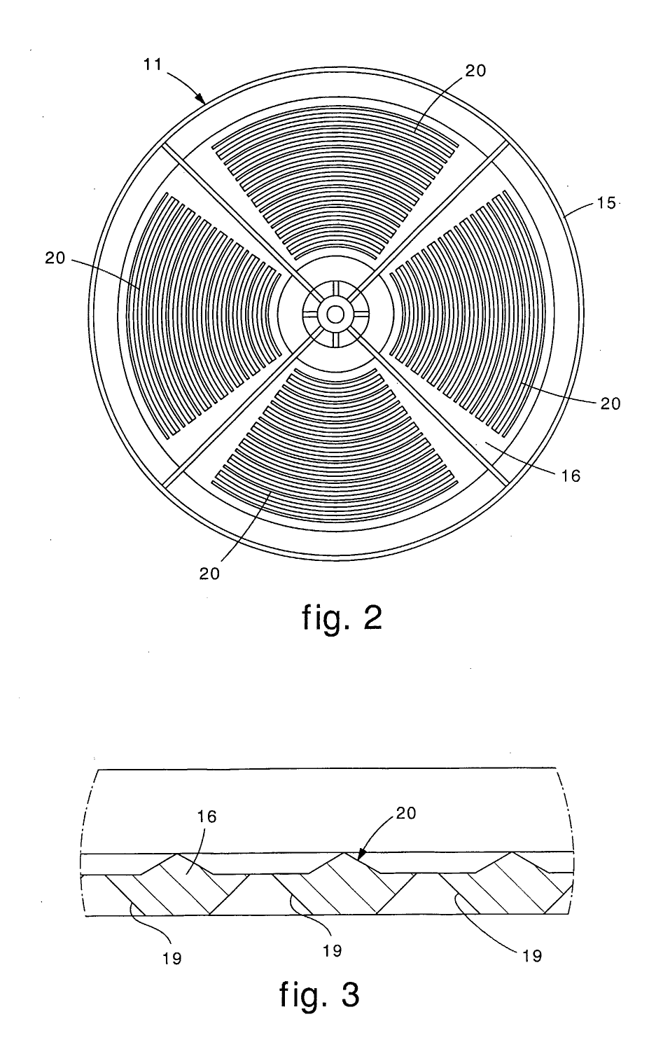

With reference to FIG. 1, a domestic seeding device 10 according to the present invention comprises a plurality of substantially flat containers 11, in this case four, arranged stacked coaxially and supported by and distanced from each other by relative spacers 12, so that between each pair of adjacent containers 11 a gap 13 is created for the passage of air.

Each container 11 in this case has a substantially circular base and comprises an outer raised containing wall 15, more exactly to contain the water, a plane bottom wall 16 and a connection block 14 provided axially with a central through hole 17. Inside each container 11 a plurality of seeds are able to be deposited, not shown here, for growing relative shoots.

On the bottom wall 16 of every container 11, possibly excluding the one located at the bottom of the pile, a plurality of through apertures 19 are provided (FIGS. 1 and 3), able to allow the water poured into or emerging from the container 11 located at the top of the pile to fall like rain inside the container 11 below.

To be more exact, the through apertures 19 have a cross section shaped substantially like an upside-down V, so as to promote a correct passage of the water and to prevent the roots, which emerge from the seeds, from obstructing the passage.

Moreover, on the upper face of the bottom wall 16 four knurled sectors 20 are made, able to increase the contact surface between the seeds and the bottom wall 16 of the container 11 thus promoting a correct and more intense exchange with the water.

Each connection block 14 in this case is made axially and in a single piece with the relative bottom wall 16 and comprises at the lower part an axial connection seating 21, of a greater diameter than and coaxial with the central through hole 17, and able to house an attachment pin 22 of the corresponding spacer 12.

Each spacer 12 comprises, apart from the attachment pin 22, an axial conduit 24 and an annular supporting surface 23, arranged substantially perpendicular to the attachment pin 22 and on which the lower face of the bottom wall 16 of the container 11 above is able to rest. Moreover, the spacer 12 comprises at the lower part an attachment seating 25 coaxial with the axial conduit 24, and able to house inside it the upper end of the relative connection block 14 of the container 11 below, so as to connect the central through hole 17 and the axial conduit 24, aligned with each other.

The domestic seeding device 10 according to the invention also comprises a stopper 26 provided with a blind closing seating 27, and able to be arranged in cooperation with the upper end of the connection block 14 of the container 11 located at the top, so as to stop the upper aperture of the central through hole 17.

The stopper 26 can be removed easily, for example when the seeding device 10 is associated with irrigation systems which pump water from below and make it emerge into the container 11 located at the top of the stack.

In fact, the axial association of the spacers 12 and the containers 11 not only defines the gaps 13 through which the air passes, but also defines a single continuous channel formed by the central holes 17 and the axial conduits 24.

It is clear, however, that modifications and/or additions of parts may be made to the domestic seeding device 10 as described heretofore, without departing from the field and scope of the present invention.

For example, a single knurled sector 20, or variously shaped with ridges or similar, can extend over the whole upper face of the bottom wall 16 of every container 11.

It is also clear that, although the present invention has been described with reference to specific examples, a person of skill in the art shall certainly be able to achieve many other equivalent forms of domestic seeding device, all of which shall come within the field and scope of the present invention.

1. A domestic seeding device comprising at least two substantially flat containers able to be stacked one on top of the other, each of which is able to receive a layer of seeds for domestic cultivation of relative shoots in hydroculture, the device comprising at least a supporting and distancing element arranged between every pair of adjacent containers, and able to define between said adjacent containers a gap for the passage of a flow of air in contact with the seeds/shoots arranged in every container, said supporting and distancing element comprising an annular supporting surface on which a lower face of the bottom wall of a container is able to rest.

2. The device as in claim 1, wherein each of said containers comprises a central through hole, and wherein said supporting and distancing element comprises an axial through conduit able to be arranged aligned with said central hole, so as to allow the passage of water.

3. The device as in claim 1, wherein each of said containers comprises, on said bottom wall, a plurality of through apertures able to allow water to fall into a container below.

4. The device as in claim 3, wherein each of said through apertures has a cross section shaped substantially like an upside-down V in order to promote the passage of water.

5. The device as in claim 3, wherein an upper face of said bottom wall of each of said containers has at least a knurled part, able to increase a contact surface between the seeds/shoots and said container.

6. The device as in claim 1, wherein each of said containers comprises an axial connection seating able to at least partly house a relative supporting and distancing element.

7. The device as in claim 2, wherein said supporting and distancing element also comprises an attachment pin able to be housed inside said axial connection seating, and an attachment seating, made underneath and coaxial with said axial conduit and able to house inside it at least an upper segment of a relative container below.

8. The device as in claim 1, wherein the device also comprises a closing element, able to be associated with an upper segment of the container located at a top, so as to close an upper aperture of a relative central through hole.

9. The device as in claim 1, wherein each container has a bottom wall and an outer raised containing wall, and wherein said annular supporting surface of said supporting and distancing element is positioned at a height greater than said containing wall so as to define a gap for the passage of a flow of air between two adjacent containers.

10. The device as in claim 6, wherein said supporting and distancing element also comprises an attachment pin able to be housed inside said axial connection seating, and an attachment seating, made underneath and coaxial with said axial conduit and able to house inside it at least an upper segment of a relative container below.
